(19) United States
(12) Patent Application Publication
(10) Pub. No.: US 2014/0022501 A1
(43) Pub. Date: Jan. 23, 2014

(54) LIQUID CRYSTAL DISPLAY PANEL AND DISPLAY APPARATUS USING THE SAME

(71) Applicant: JinJie Wang, Shenzhen (CN)

(72) Inventor: JinJie Wang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/639,403

(22) PCT Filed: Aug. 28, 2012
(86) PCT No.: PCT/CN2012/080669

§ 371 Date: Oct. 4, 2012

(30) Foreign Application Priority Data
Jul. 17, 2012 (CN) 201210246766.9

(51) Int. Cl. G02F 1/1343

(52) U.S. Cl. 349/141

(57) ABSTRACT

The present invention provides a liquid crystal display (LCD) panel and a display apparatus using the same. The LCD panel comprises a first substrate, a second substrate and a liquid crystal layer. The liquid crystal layer is formed between the first substrate and the second substrate. The second substrate comprises pixels, wherein each of the pixels includes a main pixel region and a sub-pixel region, and a first ratio of the first line width to the first space in the main pixel region is different to a second ratio of the second line width to the second space in the sub-pixel region. The present invention can mitigate a color shift problem and a reduced aperture problem existing in the conventional LCD panel.

### FIELD OF THE INVENTION

The present invention relates to a field of a liquid crystal display technology, and more particularly to a liquid crystal display (LCD) panel and a display apparatus using the same.

### BACKGROUND OF THE INVENTION

Liquid crystal displays (LCDs) have been widely applied in electrical products. Currently, most of LCDs are backlight type LCDs which comprise a liquid crystal panel and a backlight module. The liquid crystal panel is composed of two transparent substrates and a liquid crystal sealed there-between.

At present, in a large-size LCD panel, for achieving a low color shift, each pixel of the LCD panel may be divided into regions of electric potential difference, so as to mitigate a color shift problem.

However, for forming the electric potential difference between the different regions of the pixel, it is required to arrange three thin film transistors (TFTs) and two gate lines in one pixel for controlling the charge thereof, thereby significantly decreasing an aperture of the pixel.

As a result, it is necessary to provide an LCD panel and a display apparatus using the same to solve the problems existing in the conventional technologies, as described above.

### SUMMARY OF THE INVENTION

The present invention provides an LCD panel and a display apparatus using the same to solve the color shift problem and the reduced aperture problem existing in the conventional LCD.

A primary object of the present invention is to provide a liquid crystal display panel, and the liquid crystal display panel comprises: a first substrate; a second substrate comprising a plurality of pixels, wherein each of the pixels includes a main pixel region and a sub-pixel region, and the main pixel region includes a plurality of first branch portions, and the first branch portions have a first line width and a first space there-between, and the and the sub-pixel region includes a plurality of second branch portions, and the second branch portions have a second line width and a second space there-between, and a first ratio of the first line width to the first space is different to a second ratio of the second line width to the second space; and a liquid crystal layer formed between the first substrate and the second substrate.

Another object of the present invention is to provide a liquid crystal display panel, and the liquid crystal display panel comprises: a first substrate; a second substrate comprising a plurality of pixels, wherein each of the pixels includes a main pixel region and a sub-pixel region, and the main pixel region includes a plurality of first branch portions, and the first branch portions have a first line width and a first space there-between, and the and the sub-pixel region includes a plurality of second branch portions, and the second branch portions have a second line width and a second space there-between, and a first ratio of the first line width to the first space is different to a second ratio of the second line width to the second space; and a liquid crystal layer formed between the first substrate and the second substrate; wherein, the first line width or the second line width is in a range of 1 um to 7 um, and the first ratio or the second ratio is in a range of 0.2 to 5.

A further object of the present invention is to provide a display apparatus comprising a backlight module and the above-mentioned LCD panel.

In one embodiment of the present invention, the first line width or the second line width is in a range of 1 um to 7 um.

In one embodiment of the present invention, the first space or the second space is in a range of 1 um to 7 um.

In one embodiment of the present invention, the first ratio or the second ratio is in a range of 0.2 to 5.

In one embodiment of the present invention, the first ratio or the second ratio is in a range of 0.2 to 0.9.

In one embodiment of the present invention, the first ratio or the second ratio is in a range of 2.6 to 5.

In one embodiment of the present invention, the first space is identical to the second space, and the second line width is larger than the first line width.

In one embodiment of the present invention, the first line width is identical to the second line width, and the second space is larger than the first space.

In one embodiment of the present invention, the first ratio is equal to 1, and the second ratio is greater or less than 1.

In the LCD panel and the display apparatus using the same of the present invention, with the use of the different ratios of the line width/line space, different pixel regions in each of the pixels can have different LC efficiencies, such that the different pixel regions in each of the pixels can have different brightness to achieve a low color shift. In addition, only one active element is required to be arranged in each pixel of the LCD panel of the present invention without using numerous TFTs to charge one pixel, thereby enhancing an aperture ratio of the pixels.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a partially cross-sectional view showing a liquid crystal display panel according to one embodiment of the present invention;

FIG. 2 is a layout view of pixels of the liquid crystal display panel according to one embodiment of the present invention;

FIG. 3 is an enlarged view showing a portion of FIG. 2; and

FIG. 4 is a schematic diagram showing a relationship between a line width/space of branch portions of one pixel and a corresponding LC efficiency of the liquid crystal display panel according to one embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

In addition, in the specification, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element and does not imply being necessarily positioned on the top on the basis of a gravity direction.

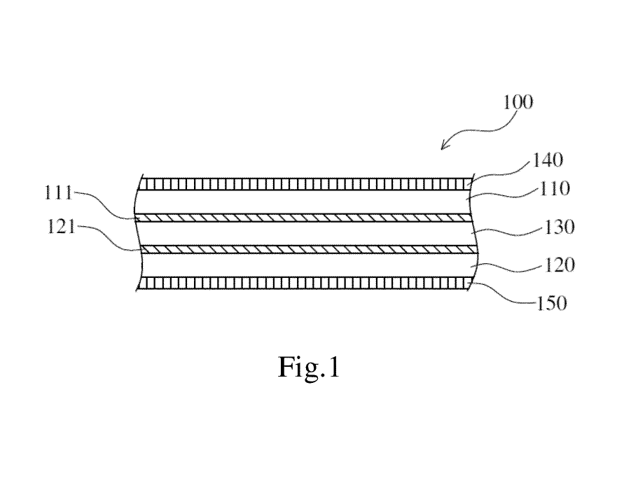

Referring to FIG. 1, a partially cross-sectional view showing a liquid crystal display (LCD) panel according to one embodiment of the present invention is illustrated. The display apparatus of the present embodiment can comprises the liquid crystal display panel 100 and a backlight module (not shown). The liquid crystal display panel 100 is disposed opposite to the backlight module, and the backlight module may be realized as a side lighting backlight module or a bottom lighting backlight module to provide the liquid crystal display panel 100 with the back-light.

Referring to FIG. 1 again, the liquid crystal display panel 100 may comprise a first substrate 110, a second substrate 120, a liquid crystal layer 130, a first polarizer 140 and a second polarizer 150. The liquid crystal layer 130 is formed between the first substrate 110 and the second substrate 120. That is, the liquid crystal layer 130 is positioned at inner sides of the first substrate 110 and the second substrate 120. The first polarizer 140 is disposed at an outer side of the first substrate 110, and the second polarizer 150 is disposed at an outer side of the second substrate 120.

Referring to FIG. 1, the first substrate 110 and the second substrate 120 may be realized as glass substrates or flexible plastic substrates. The first substrate 110 may be a glass substrate or other material substrate with color filters (CF), and the second substrate 120 may be a glass substrate or other material substrate with a thin film transistor (TFT) array. It notes that the CF and the TFT array may also be disposed on the same substrate in other embodiments.

Referring to FIG. 1 again, the first substrate 110 can comprise a first electrode layer 111, a first alignment layer, and the second substrate 120 can comprise a second electrode layer 121. The first electrode layer 111 and the second electrode layer 121 are preferably made of a transparent and electrically conductive material, such as ITO, IZO, AZO, GZO, TCO or ZnO. A voltage can be applied to the liquid crystal molecules of the liquid crystal layer 130 by the first electrode layer 111 and the second electrode layer 121. In this embodiment, the first electrode layer 111 may be a common electrode, and the second electrode layer 121 may be a pixel electrode.

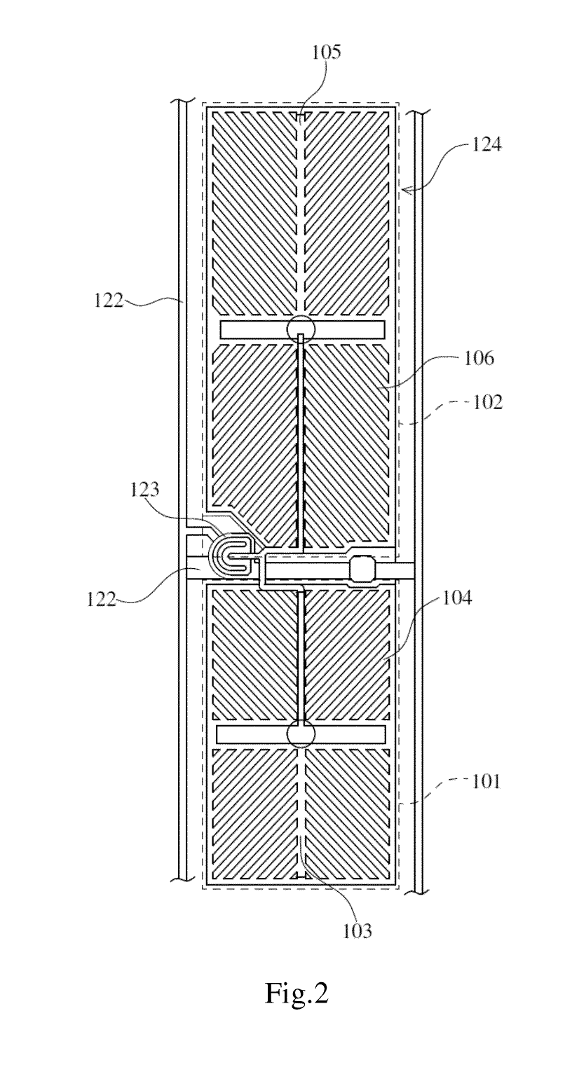

Referring to FIG. 2, a layout view of pixels of the liquid crystal display panel according to one embodiment of the present invention is illustrated. The second substrate 120 further comprises a plurality of signal lines 122, a plurality of active elements 123 and a plurality of pixels 124. The signal lines 122 may be gate lines and data lines which are crisscrossed, thereby forming the pixels 124 arranged in an array. The active elements 123 may be thin film transistors (TFTs) disposed in the pixels 124 and electrically connected to the signal lines 122 and pixel electrodes of the pixels 124, respectively. Each of the pixels 124 can corresponds to a color filter, such as a red, green or blue filter.

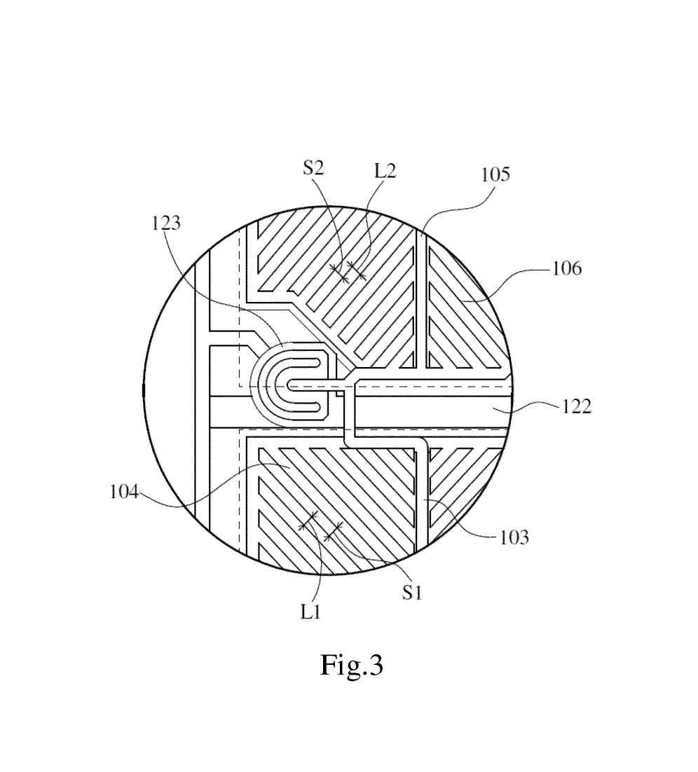

Referring to FIG. 2 and FIG. 3, FIG. 3 is an enlarged view showing a portion of FIG. 2. Each of the pixels 124 includes a main pixel region 101 and a sub-pixel region 102, wherein an area of the sub-pixel region 102 may be larger than an area of the main pixel region 101. A pixel electrode structure in each of the main pixel regions 101 includes a first trunk portion 103 and a plurality of first branch portions 104. A pixel electrode structure in each of the sub-pixel regions 102 includes a second trunk portion 105 and a plurality of second branch portions 106. The first trunk portion 103 and the second trunk portion 105 may be crisscross patterns. In each of the pixels 124, one of the active elements 123 is positioned between the main pixel region 101 and the sub-pixel region 102, and the active element 123 is connected to the first trunk portion 103 in the main pixel region 101 and the second trunk portion 105 in the sub-pixel region 102, respectively. The branch portions 104 and 106 obliquely extend from the trunk portions 103, 105, and are arranged parallel to each other. In this case, the first branch portions 104 in each of the main pixel regions 101 have an identical first line width L1 and an identical first space S1 there-between, and the second branch portions 106 in each of the sub-pixel regions 102 have a second line width L2 and a second space S2 there-between, and a first ratio (L1/S1) of the first line width L1 to the first space S1 is different to a second ratio (L2/S2) of the second line width L2 to the second space S2. Herein, the line width indicates a width of each of the branch portions, and the line space indicates a space or distance between each adjacent two of the branch portions.

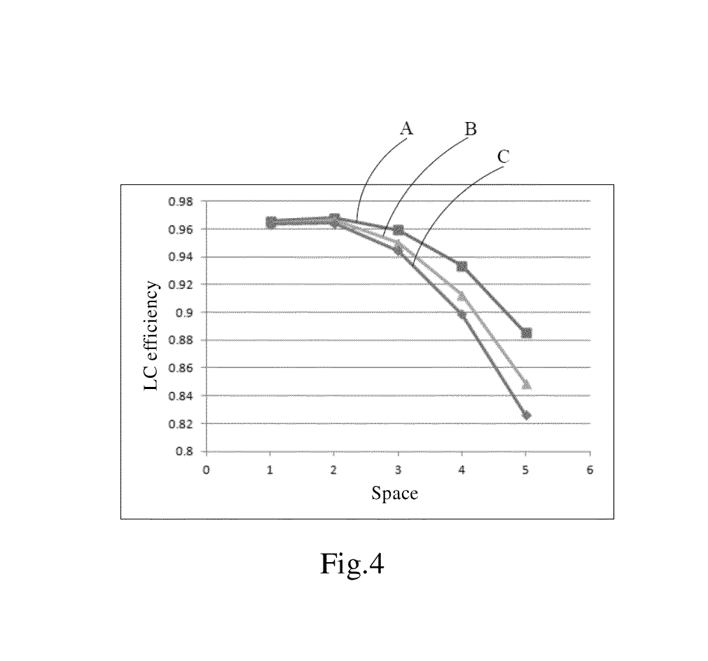

Referring to FIG. 4, FIG. 4 is a schematic diagram showing a relationship between a line width/space of the branch portions of one pixel and a corresponding LC efficiency of the liquid crystal display panel according to one embodiment of the present invention. As shown in FIG. 4, a line A indicates a relationship between different spaces and corresponding LC efficiency of the branch portions with a line width of 1 um, and a line B indicates a relationship between different spaces and corresponding LC efficiency of the branch portions with a line width of 2 um, and a line C indicates a relationship between different spaces and corresponding LC efficiency of the branch portions with a line width of 2 um. Accordingly, as shown in FIG. 4, the liquid crystal display panel 100 can have different LC efficiencies when the branch portions have different widths and/or spaces.

Therefore, by controlling a ratio of the line width to the line space, in each of the pixels 124, the main pixel region 101 and the sub-pixel region 102 can have different LC efficiencies. That is, the main pixel region 101 and the sub-pixel region 102 can have different brightness to achieve a low color shift.

In this embodiment, the line width L1 or L2 of the first branch portions 104 or the second branch portions 106 may be less than 7 um, such as in the range of 1 um to 7 um, and the line space S1 or S2 of the first branch portions 104 or the second branch portions 106 may be less than 7 um, such as in the range of 1 um to 7 um. Furthermore, the first ratio (L1/S1) or the second ratio (L2/S2) may be in the range of 0.2 to 5, such as 0.20.9 or 2.6-5, so as to mitigate the color shift problem.

In one embodiment, the line space S1 (such as 3 um) of the first branch portions 104 in the main pixel region 101 may be identical to the line space S2 of the second branch portions 106 in the sub-pixel region 102, and the line width L2 (such as 5 um) of the second branch portions 106 may be larger than the line width L1 (such as 3 um) of the first branch portions 104. According to the relationship shown in FIG. 4, at this time, the LC efficiency of the main pixel region 101 can be greater than the LC efficiency of the sub-pixel region 102, and thus the main pixel region 101 and the sub-pixel region 102 can have different brightness to achieve the low color shift.

In another embodiment, the line width L1 of the first branch portions 104 in the main pixel region 101 may be identical to the line width L2 of the second branch portions 106 in the sub-pixel region 102, and the line space S2 of the second branch portions 106 may be larger than the line space S1 of the first branch portions 104. According to the relationship shown in FIG. 4, at this time, the LC efficiency of the main pixel region 101 can be greater than the LC efficiency of the sub-pixel region 102, and thus the main pixel region 101 and the sub-pixel region 102 can have different brightness to achieve the low color shift.

In still another embodiment, the first ratio (L1/S1) of the first line width L1 to the first space S1 in the main pixel region 101 may be substantially equal to 1, and the second ratio (L2/S2) of the second line width L2 to the second space S2 in the sub-pixel region 102 may be greater or less than 1, i.e. unequal to 1. At this time, the LC efficiency of the main pixel region 101 can be different to the LC efficiency of the sub-pixel region 102, and thus the main pixel region 101 and the sub-pixel region 102 can have different brightness to achieve the low color shift.

As described above, in the LCD panel and the display apparatus of the present invention using the same, with the use of the different ratios of the line width /line space, the main pixel region and the sub-pixel region in each of the pixels can have different LC efficiencies. That is, the different pixel regions in each of the pixels can have different brightness to achieve a low color shift. In addition, only one TFT is required to be arranged in each pixel of the LCD panel of the present invention for achieving the low color shift, thereby enhancing an aperture ratio of the pixels.

The present invention has been described with a preferred embodiment thereof and it is understood that many changes and modifications to the described embodiment can be carried out without departing from the scope and the spirit of the invention that is intended to be limited only by the appended claims.

1. A liquid crystal display panel comprising:
a first substrate;
a second substrate comprising a plurality of pixels, wherein each of the pixels includes a main pixel region and a sub-pixel region, and the main pixel region includes a plurality of first branch portions, and the first branch portions have a first line width and a first space there-between, and the and the sub-pixel region includes a plurality of second branch portions, and the second branch portions have a second line width and a second space there-between, and a first ratio of the first line width to the first space is different to a second ratio of the second line width to the second space; and
a liquid crystal layer formed between the first substrate and the second substrate;
wherein, the first line width or the second line width is in a range of 1 um to 7 um, and the first ratio or the second ratio is in a range of 0.2 to 5.

2. The liquid crystal display panel according to claim 1, wherein the first space or the second space is in a range of 1 um to 7 um.

3. The liquid crystal display panel according to claim 1, wherein the first ratio or the second ratio is in a range of 0.2 to 0.9.

4. The liquid crystal display panel according to claim 1, wherein the first ratio or the second ratio is in a range of 2.6 to 5.

5. The liquid crystal display panel according to claim 1, wherein the first space is identical to the second space, and the second line width is larger than the first line width.

6. The liquid crystal display panel according to claim 1, wherein the first line width is identical to the second line width, and the second space is larger than the first space.

7. The liquid crystal display panel according to claim 1, wherein the first ratio is equal to 1, and the second ratio is greater or less than 1.

8. A liquid crystal display panel comprising:
a first substrate;
a second substrate comprising a plurality of pixels, wherein each of the pixels includes a main pixel region and a sub-pixel region, and the main pixel region includes a plurality of first branch portions, and the first branch portions have a first line width and a first space there-between, and the and the sub-pixel region includes a plurality of second branch portions, and the second branch portions have a second line width and a second space there-between, and a first ratio of the first line width to the first space is different to a second ratio of the second line width to the second space; and
a liquid crystal layer formed between the first substrate and the second substrate.

9. The liquid crystal display panel according to claim 8, wherein the first line width or the second line width is in a range of 1 um to 7 um.

10. The liquid crystal display panel according to claim 8, wherein the first space or the second space is in a range of 1 um to 7 um.

11. The liquid crystal display panel according to claim 8, wherein the first ratio or the second ratio is in a range of 0.2 to 5.

12. The liquid crystal display panel according to claim 11, wherein the first ratio or the second ratio is in a range of 0.2 to 0.9.

13. The liquid crystal display panel according to claim 11, wherein the first ratio or the second ratio is in a range of 2.6 to 5.

14. The liquid crystal display panel according to claim 8, wherein the first space is identical to the second space, and the second line width is larger than the first line width.

15. The liquid crystal display panel according to claim 8, wherein the first line width is identical to the second line width, and the second space is larger than the first space.

16. The liquid crystal display panel according to claim 8, wherein the first ratio is equal to 1, and the second ratio is greater or less than 1.

17. A display apparatus comprising:
a backlight module; and
a liquid crystal display panel comprising:
a first substrate;
a second substrate comprising a plurality of pixels, wherein each of the pixels includes a main pixel region and a sub-pixel region, and the main pixel region includes a plurality of first branch portions, and the first branch portions have a first line width and a first space there-between, and the and the sub-pixel region includes a plurality of second branch portions, and the second branch portions have a second line width and a second space there-between, and a first ratio of the first line width to the first space is different to a second ratio of the second line width to the second space; and
a liquid crystal layer formed between the first substrate and the second substrate.
